(19) United States
(12) Patent Application Publication
(10) Pub. No.: US 2020/0090546 A1
(43) Pub. Date: Mar. 19, 2020

(54) SMART GLASS DEVICE AND METHOD OF INSTRUCTING WORK BY USING THE SAME

(71) Applicants: HYUNDAI MOTOR COMPANY, Seoul (KR); KIA MOTORS CORPORATION, Seoul (KR); KOREA ADVANCED INSTITUTE OF SCIENCE AND TECHNOLOGY, Daejeon (KR)

(72) Inventors: Kyeong Hwa KANG, Gunpo-si (KR); Sungho JO, Daejeon (KR); Jeesoo HA, Daejeon (KR)

(73) Assignees: HYUNDAI MOTOR COMPANY, Seoul (KR); KIA MOTORS CORPORATION, Seoul (KR); KOREA ADVANCED INSTITUTE OF SCIENCE AND TECHNOLOGY, Daejeon (KR)

(21) Appl. No.: 16/209,375

(22) Filed: Dec. 4, 2018

(30) Foreign Application Priority Data
Sep. 13, 2018 (KR) 10-2018-0109525

(51) Int. Cl. G09B 19/00; G06K 7/14; G02B 27/01; G06F 3/16

(52) U.S. Cl. CPC G09B 19/0069; G06K 7/1413; G02B 27/0172; G02B 2027/014; G06F 3/167; G02B 2027/0178; G02B 2027/0138; G06K 7/1443

(57) ABSTRACT

A smart glass device includes: a communication unit, which communicates with a remote monitoring system; a display in a form of a glass lens; a sound output unit; and a control unit. In particular, the control unit transmits an identification code of a work target to the remote monitoring system and receives a work instruction image or a work instruction voice corresponding to the identification code, and displays the work instruction image on the display or outputs the work instruction voice through the sound output unit.

### CROSS-REFERENCE TO RELATED APPLICATION

This application claims priority to and the benefit of Korean Patent Application No. 10-2018-0109525, filed on Sep. 13, 2018, the entire contents of which are incorporated herein by reference.

### FIELD

The present disclosure relates to a smart glass device and a method of instructing work by using the same.

### BACKGROUND

The statements in this section merely provide background information related to the present disclosure and may not constitute prior art.

In an automobile factory, such as a car body factory and a design factory, it is a principle to do work, such as inspection, assembling, and fastening, according to a work order. However, it is difficult for a worker to usually perform work while reading a work order, so that the worker may also do work of dividing various components, such as a cap, a cable, a connector, and a tube, according to the kind of vehicle and fastening the components through learning.

However, when the worker works depending on learning, an error may be generated in the work according to a skill and a condition of the worker.

The above information disclosed in this Background section is only for enhancement of understanding of the background of the present disclosure and therefore it may contain information that does not form the prior art that is already known to a person of ordinary skill in the art.

### SUMMARY

The present disclosure provides a smart glass device, which is capable of improving work efficiency and decreasing a work error, and a method of instructing work by using the same. An exemplary form of the present disclosure provides a smart glass device includes: a communication unit, which communicates with a remote monitoring system; a display in a form of a glass lens; a sound output unit; and a control unit, which transmits an identification code of a work target to the remote monitoring system and receives a work instruction image or a work instruction voice corresponding to the identification code, and displays the work instruction image on the display or outputs the work instruction voice through the sound output unit.

The smart glass device may further include an image input unit, in which the identification code may be automatically recognized through an identification code image input through the image input unit.

The control unit may transmit a work image input through the image input unit to the remote monitoring system in real time during an execution of a remote support function.

The control unit may receive a work support image, in which a capture image of a work image is combined with a graphic object for instructing work, from the remote monitoring system during an execution of a remote support function.

The smart glass device may further include a sound input unit, and the control unit may transmit a worker's voice input through the sound input unit to the remote monitoring system in real time during an execution of a remote support function.

The control unit may receive a work support voice from the remote monitoring system in real time during an execution of a remote support function, and output the work support voice through the sound output unit in real time.

When work corresponding to the work instruction image or the work instruction voice is completed, the control unit may transmit work completion information to the remote monitoring system so as for the remote monitoring system to manage a work history.

Another exemplary form of the present disclosure provides a method of instructing work through a smart glass device, the method including: obtaining an identification code image through a camera of the smart glass device; extracting, by a control unit of the smart glass device, an identification code corresponding to a work target from the identification code image; transmitting, by the control unit of the smart glass device, the identification code to a remote monitoring system; receiving, by the control unit of the smart glass device, a work instruction image or a work instruction voice corresponding to the identification code from the remote monitoring system; and outputting, by the control unit of the smart glass device, the work instruction image or the work instruction voice.

The method may further include: one-to-one connection between the smart glass device and the remote monitoring system when an execution of a remote support function is requested; and transmitting a work image input through the camera of the smart glass device to the remote monitoring system in real time.

The method may further include receiving a work support image, in which a capture image of a work image is combined with a graphic object for instructing work, from the remote monitoring system during the execution of the remote support function.

The method may further include transmitting a worker's voice input through a sound input device of the smart glass device to the remote monitoring system in real time during the execution of the remote support function.

The method may further include: receiving a work support voice from the remote monitoring system during the execution of the remote support function; and outputting the work support voice in real time.

The method may further include when work corresponding to the work instruction image or the work instruction voice is completed, transmitting work completion information to the remote monitoring system so as for the remote monitoring system to manage a work history.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a block diagram schematically illustrating a work instructing system;

FIG. 2 is a diagram illustrating an installation example of a projection device;

FIG. 3 is a block diagram schematically illustrating the projection device; and

FIG. 4 is a flow chart illustrating a method of instructing work by a work instruction system.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

As those skilled in the art would realize, the described forms may be modified in various different ways, all without departing from the spirit or scope of the present disclosure.

A part irrelevant to the description will be omitted to clearly describe the present disclosure, and the same elements will be designated by the same reference numerals throughout the specification.

Throughout this specification and the claims that follow, when it is described that an element is “coupled” to another element, the element may be “directly coupled” to the other element or “electrically coupled” to the other element through a third element. In addition, unless explicitly described to the contrary, the word “comprise” and variations such as “comprises” or “comprising”, will be understood to imply the inclusion of stated elements but not the exclusion of any other elements.

It should be understood that every element of the forms is not described herein, and general content in the technical field to which the present disclosure pertains or overlapping parts between forms are not described herein. As used herein, the terms “unit”, “module”, and “block” may be implemented as software or hardware (e.g., a microprocessor), and a plurality of units, modules, or blocks may be integrated into one element or one unit, module, or block may include a plurality of elements in accordance with embodiments.

Hereinafter, a work instruction system according to an exemplary form of the present disclosure and a method thereof will be described with reference to the necessary drawings.

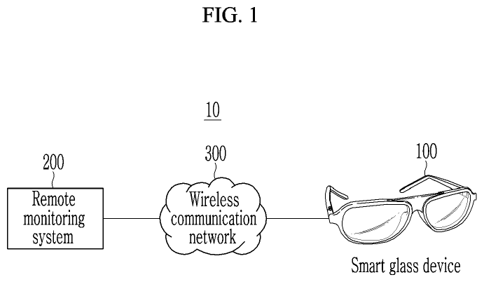

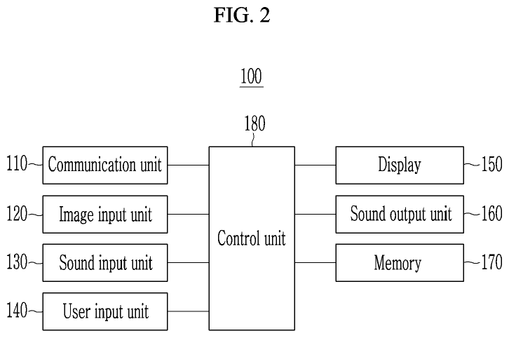

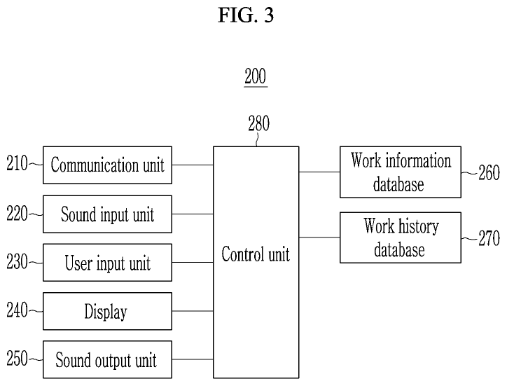

FIG. 1 is a diagram schematically illustrating a work instruction system according to an exemplary form of the present disclosure, FIG. 2 is a diagram schematically illustrating a smart glass device according to the exemplary form of the present disclosure, and FIG. 3 is a diagram schematically illustrating a remote monitoring system according to the exemplary form of the present disclosure.

Referring to FIG. 1, a work instruction system 10 may include a smart glass device 100 and a remote monitoring system 200.

The smart glass device 100 may receive work information from the remote monitoring system 200, and convert the received work information into a voice signal or an image signal and output the voice signal or the image signal. Further, the smart glass device 100 may transmit work result information to the remote monitoring system 200. To this end, the smart glass device 100 may communicate with the remote monitoring system 200 through a wireless communication network 300.

Referring to FIG. 2, the smart glass device 100 may include a communication unit 110, an image input unit 120, a voice input unit 130, a user input unit 140, a display 150, a sound output unit 160, a memory 170, and a control unit 180.

The communication unit 110 may transceive data with the remote monitoring system 200 through the wireless communication network 300.

The image input unit 120 is for inputting an image signal, and may include a camera.

The sound input unit 130 is for inputting a sound signal, and may include a sound input device, such as a microphone.

The user input unit 140 is for receiving a user input for controlling an operation of the smart glass device 100 from a user, and may include various user input devices, such as a button, a key pad, and a touch pad.

The display 150 may display information processed by the smart glass device 100. The display 150 may be a transparent display, through which an object is seen through.

The sound output unit 160 is for outputting a sound signal, and may include various sound output device, such as a receiver and a speaker.

The memory 170 may store a program for an operation of the control unit 180, and may temporarily store data processed by the smart glass device 100.

The control unit 180 may control a general operation of the smart glass device 100.

The control unit 180 may obtain an image of an identification code (a bar code or a quick response (QR) code) attached to a work target (for example, a vehicle) through the image input unit 120, and automatically extract the identification code (the bar code or the QR code) through recognition of the image. The control unit 180 may transmit the identification code (the bar code or the QR code) extracted through recognition of the image to the remote monitoring system 200 to request for work information about the work target.

When the work information about the work target is received from the remote monitoring system 200, the control unit 180 may convert the work information into an image signal and display the converted image signal through the display 150. Further, the control unit may convert the work information received from the remote monitoring system 200 into a sound signal and output the sound signal through the sound output unit 160. The work information received from the remote monitoring system 200 may include work target information (information on the kind of vehicle, assembling specification information, and the like) and work guide information (a work instruction image and a work instruction voice).

When the work for the work target is completed, the control unit 180 may also transmit work result information to the remote monitoring system 200. The control unit 180 may recognize the work completion based on a control input received through the user input unit 140 or a voice command input through the voice input unit 130. When it is recognized that the work is completed, the control unit 180 may transmit work result information to the remote monitoring system 200. Herein, the work result information may include an identification code (a bar code or a QR code) of the work target, work target information (information on the kind of vehicle), work specification information, the number of work, work completion time, worker identification information, information about whether the work is completed, and the like.

The control unit 180 may also execute a remote support function through real-time data transception with the remote monitoring system 200. That is, when the control unit 180 is connected with the remote monitoring system 200 through the wireless communication network 300, the control unit 180 may reproduce work support information (a work support image or a work support voice) received by a streaming scheme from the remote monitoring system 200 in real time. Further, the control unit 180 may process the image data (the work image) input through the image input unit 120 or the voice data (a worker voice) input through the voice input unit 130 by a streaming scheme and transmit the processed data to the remote monitoring system 200 in real time.

The smart glass device 100 having the foregoing structure may be implemented in the form wearable by a worker. For example, the smart glass device 100 may be implemented in the form of glasses and goggles, and in this case, the display 150 may be formed in the form of lenses of the glasses.

Referring back to FIG. 1, the remote monitoring system 200 may receive the identification code (the bar code or the QR code) from the smart glass device 100, and transmit work information corresponding to the received identification code to the smart glass device 100. Further, the remote monitoring system 200 may receive work result information from the smart glass device 100 and manage a work history by using the received work result information.

Referring back to FIG. 3, the remote monitoring system 200 may include a communication unit 210, a voice input unit 220, a user input unit 230, a display 240, a sound output unit 250, a work information database 260, a work history database 270, and a control unit 280.

The communication unit 210 may transceive data with the smart glass device 100 through the wireless communication network 300.

The sound input unit 220 is for inputting a sound signal, and may include a sound input device, such as a microphone.

The user input unit 230 is for receiving a user input for controlling an operation of the remote monitoring system 200 from a user, and may include various user input devices, such as a button, a key pad, and a touch pad.

The display 240 may display information processed by the remote monitoring system 200. For example, when the work image is received from the smart glass device 100, the display 240 may display the received work image on a screen. Further, when the work completion information is received from the smart glass device 100, the display 240 may display the received work completion information on the screen.

The voice output unit 250 is for outputting a voice signal in the remote monitoring system 200, and may include various sound output devices, such as a receiver and a speaker.

The work information database 260 may store and manage work information provided from the remote monitoring system 200. The work information database 260 may divide and store corresponding work information according to a work target. The work information database 260 may divide and store corresponding work information according to an identification code (a bar code or a QR code) of a work target.

The work history database 270 may store and manage the work history information received from the smart glass device 100. The work history database 270 may divide and store the corresponding work history information based on a work target, a work specification, a work completion time, or each worker.

The control unit 280 may control a general operation of the remote monitoring system 200.

The control unit 280 may receive an identification code (a bar code or a QR code) of a work target form the smart glass device 100, and search for work information corresponding to the received identification code in the work information database 260. Further, the control unit 280 may transmit the searched work information to the smart glass device 100.

The control unit 260 may receive the work completion information from the smart glass device 100, and store the received work completion information in the work history database 270.

The control unit 260 may also execute a remote support function through real-time data transception with the smart glass device 100. That is, when the control unit 260 is connected with the smart glass device 100 through the wireless communication network 300, the control unit 260 may transmit work support information (a work support image or a work support voice) to the smart glass device 100 by a streaming scheme in real time. Further, the control unit 260 may receive feedback information (a work image and a worker voice) from the smart glass device 100 by a streaming scheme in real time, and reproduce the received feedback information through the display 240 or the sound output unit 250 in real time.

The work information transmitted to the smart glass device 100 in real time during the execution of the remote support function may include the work information (the work support image and the work support voice) read from the work information database 260 in accordance with the identification code (the barcode or the QR code) of the work target received from the smart glass device 100. Further, the work support information transmitted to the smart glass device 100 in real time during the execution of the remote support function may include voice data (a work support voice) input through the voice input unit 220. Further, the work support information transmitted to the smart glass device 100 in real time during the execution of the remote support function may include image data or voice data obtained by re-producing the feedback information received from the smart glass device 100. For example, the control unit 260 may combine a capture image obtained by capturing the work image received from the smart glass device 100 during the execution of the remote support function and work support text or a work support graphic object input through the user input unit 230, re-produce image data, and transmit the re-produced image data to the smart glass device 100.

The feedback information received from the smart glass device 100 during the execution of the remote support function may include image data (work image) photographed by the smart glass device 100 in real time, voice data (work voice) recorded by the smart glass device 100 in real time, and the like.

The control unit 260 may record the work image or the work voice received from the smart glass device 100 during the execution of the remote support function, and store the recorded work image or worker voice in the work history database 270.

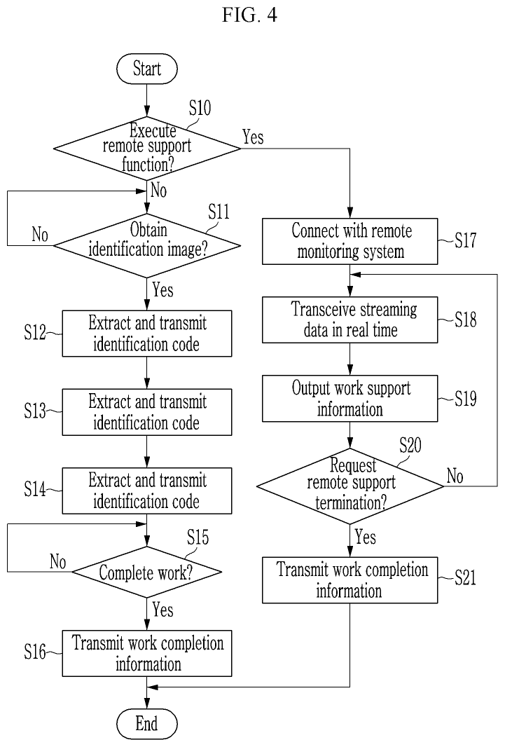

Hereinafter, a method of instructing work according to an exemplary form of the present disclosure will be described in detail with reference to FIG. 4.

FIG. 4 is a diagram schematically illustrating a method of instructing work. The method of instructing work of FIG. 4 may also be performed by the smart glass device 100 described with reference to FIGS. 1 and 2.

Referring to FIG. 4, when the smart glass device 100 according to the exemplary form of the present disclosure does not execute a remote support function (S10), but is operated in order to receive work information from the remote monitoring system 200, the smart glass device 100 waits for obtaining image of an identification code (a barcode or a QR code) attached to a work target (S11).

Then, when the smart glass device 100 obtains the image of the identification code (the barcode or the QR code), the smart glass device 100 extracts the identification code (the barcode or the QR code) from the image of the identification code (the barcode or the QR code) through the recognition of the image, transmits the extracted identification code (the barcode or the QR code) to the remote monitoring system 200, and requests for work information (S12). The remote monitoring system 200 receiving the identification code (the barcode or the QR code) from the smart glass device 100 may search for work information corresponding to the identification code from the work information database 260 and transmit the searched work information to the smart glass device 100.

When the smart glass device 100 receives the work information from the remote monitoring system 200 (S13), the smart glass device 100 outputs the received work information through the display 150 or the sound output unit 160 (S14).

Then, when the work corresponding to the work information received from the remote monitoring system 200 is completed (S15), the smart glass device 100 transmits work result information to the remote monitoring system 200 (S16).

In operation S15, the smart glass device 100 may recognize the work completion based on a control input through the user input unit 140 or a voice command input through the voice input unit 130.

In operation S16, the work result information transmitted to the remote monitoring system 200 may include the identification code (the bar code or the QR code) of the work target, work target information (information on the kind of vehicle), work specification information, the number of work, work completion time, worker identification information, information about whether the work is completed, and the like.

In the meantime, when an execution of a remote support function is requested (S10), the smart glass device 100 connects the remote monitoring system 200 one to one for executing the remote support function (S17).

Then, the smart glass device 100 transceives streaming data with the remote monitoring system 200 in real time according to the connection with the remote monitoring system 200, so that the smart glass device 100 executes the remote support function (S18).

In operation S18, the smart glass device 100 may receive work support information (a work support image or a work support voice) in the streaming form from the remote monitoring system 200 in real time, and process image data (a work image) input through the image input unit 120 or voice data (worker's voice) input through the sound input unit 130 in the streamlining form and transmit the processed data to the remote monitoring system 200 in real time.

In the meantime, when the smart glass device 100 receives the work support information from the remote monitoring system 200 during the execution of the remote support function, the smart glass device 100 outputs the received work support information through the display 150 and the sound output unit 160 in real time (S20).

The smart glass device 100 continues the transception of the data with the remote monitoring system 200 in real time until a request for remote support termination is received through the user input unit 140 (S20), and when the request for the remote support termination is received, the smart glass device 100 terminates the one-to-one connection with the remote monitoring system 200 (S21).

According to the exemplary form, the work instruction system 10 may automatically recognize a work target by using the smart glass device 100 and provide work information corresponding to the recognized work target to a worker, thereby improving work efficiency of a worker. Further, the work instruction system 10 guides work through a work instruction image or a work instruction voice to support a worker to easily recognize work information. Further, it is possible to provide appropriate work support information in accordance with a real-time work situation through the remote support function, thereby improving work efficiency and preventing a work error.

The method of instructing work according to the exemplary form of the present disclosure may be executed through software. When the method is executed through the software, configuration means of the present disclosure are code segments executing required work. A program or the code segments may be stored in a processor readable medium.

A computer readable recording medium includes all kinds of recording device, in which data readable by a computer system is stored. Examples of the computer readable recording device includes a read only memory (ROM), a random access memory (RAM), a compact disc (CD)-ROM, a digital video disc (DVD)_ROM, a DVD_RAM, a magnetic tape, a floppy disk, a hard disk, an optical data storage device, and the like. Further, the computer readable recording medium is distributed to a computer device connected through a network, so that a computer readable code may be stored and executed by a distribution scheme.

The foregoing referenced drawings and detailed description of the present disclosure are all exemplary and do not limit the meaning or the scope of the present disclosure. Accordingly, the configuration of the present disclosure may be easily selected and replaced from the detailed description of the present disclosure by those skilled in the art. Further, those skilled in the art may omit some of the constituent elements described in the present specification without deterioration of performance or add a constituent element for improving performance. In addition, those skilled in the art may also change an order of the operations of the method described in the present specification according to a process environment or equipment.

While this present disclosure has been described in connection with what is presently considered to be practical exemplary forms, it is to be understood that the present disclosure is not limited to the disclosed forms, but, on the contrary, is intended to cover various modifications and equivalent arrangements included within the spirit and scope of the present disclosure.

What is claimed is:

1. A smart glass device, comprising:
a communication unit configured to communicate with a remote monitoring system;
a display in a form of a glass lens;
a sound output unit; and
a control unit configured to:
transmit an identification code of a work target from the remote monitoring system,
receive a work instruction image or a work instruction voice corresponding to the identification code, and
display the work instruction image on the display or output the work instruction voice through the sound output unit.

2. The smart glass device of claim 1, further comprising:
an image input unit,
wherein the identification code is automatically recognized through an identification code image input through the image input unit.

3. The smart glass device of claim 2, wherein:
the control unit is configured to transmit a work image input through the image input unit to the remote monitoring system in real time during an execution of a remote support function.

4. The smart glass device of claim 2, wherein:
the control unit is configured to receive a work support image, in which a capture image of a work image is combined with a graphic object for instructing work, from the remote monitoring system during an execution of a remote support function.

5. The smart glass device of claim 2, further comprising:
a sound input unit,
wherein the control unit is configured to transmit an input of a voice of a worker through the sound input unit to the remote monitoring system in real time during an execution of a remote support function.

6. The smart glass device of claim 2, wherein:
the control unit is configured to receive a work support voice from the remote monitoring system during an execution of a remote support function, and configured to output the work support voice through the sound output unit in real time.

7. The smart glass device of claim 1, wherein:
when work corresponding to the work instruction image or the work instruction voice is completed, the control unit is configured to transmit work completion information to the remote monitoring system so as for the remote monitoring system to manage a work history.

8. A method of instructing work through a smart glass device, the method comprising:
obtaining an identification code image through a camera of the smart glass device;
extracting, by a control unit of the smart glass device, an identification code corresponding to a work target from the identification code image;
transmitting, by the control unit of the smart glass device, the identification code to a remote monitoring system;
receiving, by the control unit of the smart glass device, a work instruction image or a work instruction voice corresponding to the identification code from the remote monitoring system; and
outputting, by the control unit of the smart glass device, the work instruction image or the work instruction voice.

9. The method of claim 8, further comprising:
one-to-one connection between the smart glass device and the remote monitoring system when an execution of a remote support function is requested; and
transmitting a work image input through the camera of the smart glass device to the remote monitoring system in real time.

10. The method of claim 9, further comprising:
receiving a work support image, in which a capture image of a work image is combined with a graphic object for instructing work, from the remote monitoring system during the execution of the remote support function.

11. The method of claim 9, further comprising:
transmitting an input of a voice of a worker through a sound input device of the smart glass device to the remote monitoring system in real time during the execution of the remote support function.

12. The method of claim 9, further comprising:
receiving a work support voice from the remote monitoring system during the execution of the remote support function; and
outputting the work support voice in real time.

13. The method of claim 8, further comprising:
when work corresponding to the work instruction image or the work instruction voice is completed, transmitting work completion information to the remote monitoring system so as for the remote monitoring system to manage a work history.
